(19) United States
(12) Patent Application Publication
(10) Pub. No.: US 2026/0201910 A1
(43) Pub. Date: Jul. 16, 2026

(54) CYLINDER

(71) Applicant: Festo SE & Co. KG, Esslingen (DE)

(72) Inventors: Johannes VOLZER, Heroldstatt (DE); Daniel WALDNER, Nürtingen (DE)

(21) Appl. No.: 19/446,398

(22) Filed: Jan. 12, 2026

(30) Foreign Application Priority Data
Jan. 14, 2025 (DE) 102025101150.8

(51) Int. Cl. F15B 15/14

(52) U.S. Cl. CPC F15B 15/1442

(57) ABSTRACT

A cylinder with a housing arrangement which including a cylinder housing in which a working recess for receiving a piston arrangement, the piston arrangement being linearly movable along a movement axis by way of subjecting the working recess to working fluid. The housing arrangement includes a first end cap which is fixed to the cylinder housing at the end side, the cylinder including a first base ring which is fixed to the first end cap and a first sliding ring which is fixed to the piston arrangement, the housing arrangement including a main movement region, a first damping region and a first venting region. The piston arrangement is movable into a first end position which corresponds to the first venting region, the first sliding ring can be brought onto the first base ring by way of a first sliding moment which runs along a sliding axis.

### CROSS REFERENCE TO RELATED APPLICATION

This application claims priority to German Patent Application No. 102025101150.8 filed January 14, 2025, which is incorporated by reference.

### BACKGROUND

The invention relates to a cylinder.

Cylinders are drives which are operated with a working fluid, for example hydraulically or pneumatically and which comprise a housing arrangement with cylinder housing. A working recess in which a piston arrangement is received is formed in the cylinder housing, said piston arrangement being linearly moveable along a movement axis due to the working recess being subjected to working fluid. The piston arrangement is movable into at least one end position. On moving into the end position, it is advantageous if the movement of the piston arrangement is braked, in order to render possible a reliable and targeted moving into the end position. Such a braking is also denoted as an end position damping. In order to permit an end position damping, regarding known cylinders additional components of the cylinder are provided. These additional components require additional construction space, in particular along the movement axis.

### SUMMARY

It is the object of the invention to provide an improved cylinder with an end position damping.

This object is achieved by a cylinder according to claim 1.

The cylinder according to the invention comprises a housing arrangement which comprises a cylinder housing in which a working recess is formed, in which working recess a piston arrangement is received, said piston arrangement being linearly movable along a movement axis by way of subjecting the working recess to working fluid, wherein the housing arrangement further comprises a first end cap which is fixed to the cylinder housing at the end side, wherein the cylinder comprises a first base ring which is fixed to the first end cap and a first sliding ring which is fixed to the piston arrangement, wherein the housing arrangement comprises a main movement region, a first damping region which is adjacent to the main movement region and a first venting region which is adjacent to the first damping region, wherein the piston arrangement is movable into a first end position which corresponds to the first venting region, wherein the first sliding ring can be brought onto the first base ring by way of a first sliding moment which runs along a sliding axis, so that along the sliding axis, a first sliding surface of the first sliding ring which faces the first base ring at least partly covers a first base surface of the first base ring which faces the first sliding ring, wherein the first base ring comprises a first base venting section on the first base surface, wherein the first sliding ring comprises a first sliding venting section on the first sliding surface, wherein the first base venting section and/or the first sliding venting section are deepened, wherein the first base venting section is arranged in the first venting region, wherein the first base venting section and the first sliding venting section are fluidically connected to one another when the piston arrangement is situated in the first end position, in order to vent the working recess, wherein the first base ring on the first base surface comprises a first base sealing section which is radially closed in a circumferential manner and is arranged in the first damping region and the first sliding ring on the first sliding surface comprises first sliding sealing section which is radially closed in a circumferential manner, wherein the first base venting section and the first sliding venting section are fluidically separated from one another when the first base sealing section covers the first sliding sealing section along the sliding axis and the first sliding ring is situated in the first sliding movement, wherein the first end cap comprises a first fluid opening which permits a fluidic connection of the working recess to a fluid device.

The piston arrangement in the working recess fluidically delimits at least one pressure chamber, in particular two pressure chambers which are hereinafter denoted as a first pressure chamber and second pressure chamber. If a first pressure chamber and a second pressure chamber are provided, then these are fluidically separated from one another by way of a piston arrangement. Due to a movement of the piston arrangement within the working recess, depending on the movement direction the volume of the one of the two pressure chambers, for example the volume of the first pressure chamber increases and the volume of the other of the two pressure chambers, for example the volume of the second pressure chamber reduces to the same extent. Given a reverse movement direction, the volume of the second pressure chamber would then increase and the volume of the first pressure chamber reduce. The fluidic delimitation or the fluidic separation of the two pressure chambers is rendered possible by way of the provision of at least one suitable seal. In particular, this seal is fixed to an outer periphery of the piston arrangement which faces an inner wall of the working recess, and bears on this inner wall.

The piston arrangement is moved by way of subjecting the working recess, in particular one of the two pressure chambers to working fluid. If for example the first pressure chamber is subjected to working fluid, thus is pressurised, a pressure of the working fluid which is received in the first pressure chamber increases, whereupon the volume of the first pressure chamber is enlarged and the volume of the second pressure chamber accordingly reduced, due to a pressure equalisation with regard to a pressure of the working fluid which is received in the second pressure chamber. At the same time, the second pressure chamber can be vented to the extent to which the first pressure chamber is pressurised, which is to say that working fluid which is present in the second pressure chamber is removed from this.

A hydraulic fluid or a working gas can be used as a working fluid. Preferably, the cylinder is designed as a pneumatic cylinder and pressurised air is used as a working fluid.

The pressurising and venting of the working recess is effected via the first fluid opening which permits a fluidic connection of the working recess to the fluid device. The fluid device can comprise a fluid sink and/or a fluid source and/or control a fluidic connection of the working recess to the fluid sink and/or the fluid source. If the working recess is fluidically connected to the fluid sink, then the working recess is vented. If the working recess is fluidically connected to the fluid source, then the working recess is pressurised. In particular, the fluid device comprises at least one valve with which a fluidic connection of the working recess to the fluid sink and/or the fluid source can be controlled. If a first pressure chamber and a second pressure chamber are provided, then these are each pressurised and/or vented. In order to permit this, at least one valve can be fluidically connected to the first pressure chamber and/or to the second pressure chamber. For example, an individual valve which is fluidically connected to the first pressure chamber and the second pressure chamber can be provided. Alternatively, a valve which is fluidically connected to the first pressure chamber and another valve which is fluidically connected to the second pressure chamber can be provided.

The first sliding ring can be brought onto the first base ring in a manner such that as soon as the first base surface and the first sliding surface partly overlap, a further bringing of the first sliding ring onto the first base ring is assisted by way of a continuation of the first sliding movement due to the first sliding surface sliding away on the first base surface. The first base surface herein serves as a plain bearing for the first sliding surface, by which means the first base ring serves as a plain bearing for the first sliding ring. The first sliding ring can be removed from the first base ring by way of a movement which is opposite to the first sliding movement. Hereby, the first base ring at all events also serves as a plain bearing for the first sliding ring, until the first base surface and the first sliding surface once again no longer partly overlap.

Preferably, the first sliding ring is formed from an elastomer, in particular from a thermoplastic elastomer. For example, the first sliding ring is formed from a polyurethane, an acrylonitrile butadiene rubber, a fluorinated rubber or ethylene-propylene-diene rubber. Further preferably, the first base ring is formed from a metal or a plastic, in particular thermoplastic plastic. For example, the first base ring is formed from a polyoxymethylene, a polyphenylene sulphide with a base surface of polytetrafluoroethylene, a bronze alloy or an anodised aluminium. Alternatively, the first base ring can be designed of glass for applications in the field of laboratory equipment or filling facilities.

The first sliding movement runs along the sliding axis and is therefore linear. Depending on the movement direction, with the first sliding movement the first sliding ring can be brought onto the first base ring as described above or can be removed from this by way of a movement which is directed opposite to the first sliding movement.

If the piston arrangement is situated in the first end position, then the first base venting section at least partly covers the first sliding venting section along the sliding axis. In the first venting position, a working fluid can herewith pass through via the deepened first base venting section and/or the deepened first sliding venting section. The larger the overlapping surface between the first base venting section and the first sliding venting section, the more working fluid can pass through the venting device in the aforementioned manner. The overlapping surface can be enlarged by way of the first sliding ring being brought further onto the first base ring, so that an overlapping length which is pronounced along sliding axis is enlarged. The overlapping surface can furthermore be enlarged by way of the deepening of the first base venting section and/or the deepening of the first sliding venting section being enlarged, in particular along the sliding axis.

The base venting section and/or the sliding venting section can comprise corresponding individual deepenings which ensure that the respective section is deepened. These deepenings can each be deepened in a perpendicular manner. Alternatively, the deepenings can be deepened in a tapering manner. Further alternatively, the deepenings can be deepened in a widening manner. A perpendicular deepening is characterised in that a constant deepening cross section is present independently of the depth. A tapering deepening is characterised in that the deepening cross section becomes increasingly smaller with an advancing depth. A widening deepening is characterised in that the deepening cross section becomes increasingly larger with an advancing depth.

On venting the working recess, a fluidic connection is created between the working recess and an environment which surrounds the working recess, so that working fluid which is present in the working recess at least partially exits from the working recess into the environment.

On account of the first base sealing section and the first sliding sealing section, one succeeds in the working fluid not being able to pass through via the first base venting section and/or the first sliding venting section when the first base ring and the first sliding ring merely overlap in the region of the first base sealing section and/or of the first sliding sealing section. When, on account of a movement of the piston arrangement towards the first end position, the sliding sealing section of the first sliding ring fixed to the piston arrangement enters into the first damping region in a manner such that the first sliding sealing section bears on the first base sealing section, the first base sealing section and/or the first sliding sealing section ensure that the piston arrangement is initially braked. The working recess is subsequently vented as soon as the piston arrangement with a continuing first sliding movement reaches the first end position, by which means the first base venting section and the first sliding venting section are fluidically connected to one another.

The initial braking of the piston arrangement is part of the end position damping and is achieved due to the fact that a venting of the part of the working recess into which working recess the piston arrangement moves, which is to say of its volume, is reduced and/or prevented by way of the movement of the piston arrangement on account of the first base sealing section and/or the first sliding sealing section. By way of the reduction or prevention of the venting and the reduction of the volume, the pressure of the working fluid which is received in this part of the working recess, for example of the first pressure chamber, is increased, by which means the resistance which is counter to the movement of the piston arrangement is increased and finally the piston arrangement is braked, in particular in an increasing manner. After a continuation of the movement of the piston arrangement towards a position in which the first base sealing section and/or the first sliding sealing section are no longer aligned to one another in a manner such that a venting of the aforementioned part of the working recess is prevented, in particular into the first end position, this part of the working recess is abruptly vented.

The movement axis preferably runs parallel to the sliding axis. By way of this, a resistance which opposes the sliding movement can be reduced.

Preferably, the first base ring comprises at least one venting channel which is fluidically connected to the first fluid opening, wherein the venting channel is fluidically connected to the working recess independently of the position of the first sliding ring. This means that the venting channel is fluidically connected to the working recess in particular when the piston arrangement is situated in the main movement region or in the first venting region, and when the first base sealing section covers the first sliding sealing section along the sliding axis. By way of this, the working recess can be vented independently of the position of the sliding ring, wherein this share of the venting which is also denoted as continuous venting, can preferably be set depending on the demands by way of a suitable design of the venting channel, in particular with regard to its cross section. If the continuous venting is to be done to a greater extent, the cross section of the venting channel is to be selected larger than if the continuous venting is to be done to a lesser extent. The venting channel can be orientated in a manner such that its longitudinal axis runs parallel to the movement axis, but also such that its longitudinal axis runs obliquely to the movement axis. Further preferably, the first base ring comprises several venting channels, for example two, three, four, five or more than five, for example more than ten venting channels.

Preferably, the piston arrangement comprises a working piston and a piston rod which is fixed to the working piston, wherein the piston rod passes through the first end cap. A part of the working recess is fluidically separated by way of the working piston. In particular, the first pressure chamber is fluidically separated from the second pressure chamber by way of the working piston. The piston rod serves for carrying out the linear movement out of the cylinder.

Preferably, the piston rod passes through the first base ring. In other words, the first base ring surrounds the piston rod.

Preferably, the first base ring comprises a first base sliding surface which is arranged opposite to the first base surface and on which the piston rod is mounted in a slidingly movable manner. Herewith, the first base ring is not only suitable for providing an end position damping function, but also as a plain bearing for the piston rod and thus for the piston arrangement. By way of this, a construction space which is necessary for the cylinder along the movement axis can be reduced.

Preferably, the venting channel is designed as an open deepening of the first base sliding surface. The venting channel can herein also serve as a guide for a lubricant which ensures that a resistance which opposes the sliding of the piston rod on the first base sliding surface is reduced. Furthermore, the venting channel can be designed as a slot, which is to say as a deepening which locally passes through the first base ring in a complete manner.

Alternatively, the venting channel passes through the first base ring without herein running out at the first base sliding surface or at the first base surface which is to say without being exposed on the first base sliding surface or on the first base surface.

Preferably, in the first base venting section, a first base diameter which extends perpendicularly to the sliding axis reduces with an increasing distance to the first base sealing section. On account of the aforementioned increasing reduction of the first base diameter, when the first sliding ring embraces the first base ring, the volume which is spanned between the first base surface and the first sliding surface in the region in which the first base venting section and the first sliding venting section overlap along the sliding axis is enlarged the further the first sliding venting section is moved in the direction of the first end position. The quantity of working fluid which can pass, for example be vented through the aforementioned region also increases with this volume.

Alternatively, in the first base venting section, a first base diameter which extends perpendicularly to the sliding axis enlarges with an increasing distance to the first base sealing section. On account of the aforementioned increasing enlargement of the first base diameter, when the first base ring embraces the first sliding ring, the volume which is spanned between the first base surface and the first sliding surface in the region in which the first base venting section and the first sliding venting section overlap along the sliding axis is enlarged, the further the first sliding venting section is moved in the direction of the first end position. The quantity of working fluid which can pass, for example be vented through the aforementioned region increases with this volume.

Preferably, the first base ring comprises at least one venting pocket in the first base venting section. The aforementioned volume which is spanned between the first base surface and the first sliding surface can be additionally increased by way of the additional provision of a venting pocket which is designed as a respective deepening.

Preferably, the first base ring comprises at least one venting slot in the first base venting section. A venting slot is a deepening which locally passes through the first base ring in a complete manner. By way of this, one can provide a deepened first base venting section in a simple manner.

Preferably, the first base surface faces outwards and the first sliding surface faces inwards, so that the first sliding ring at least partly embraces the first base ring when the piston arrangement is situated in the first end position. Alternatively, the first base surface faces inwards and the first sliding surface faces outwards, so that the first base ring at least partly embraces the first sliding ring when the piston arrangement is situated in the first end position.

Preferably, the first base ring is designed in a sleeve-like manner. The sleeve-like first base ring has a sleeve-like basic shape. Herein, the sleeve-like first base ring can also comprise local deviations from the sleeve-like basic shape, in particular at least one venting slot. The sleeve-like basic shape is characterised by a constant outer diameter and a constant inner diameter of the first base ring along its complete length which extends along the sliding axis. By way of this, one can provide a first base ring which is simple to manufacture and/or requires less construction space.

Preferably, the first end cap comprises a first receiving deepening in which the first base ring is at least partly received. By way of this, the first base ring can be sunk at least partly in the first end cap, by which means the construction space which is required for the cylinder along the movement axis can be reduced. The first base ring in particular is received in the first receiving deepening in a manner such that a displacement of the first base ring along the movement axis is prevented.

Preferably, the first base ring is an integral constituent of the first end cap. This can be achieved by way of the first base ring being completely integrated into the first end cap. Further preferably, the first base ring and the first end cap are designed as one piece. This can be achieved by way of the first base ring being designed as a corresponding deepening of the first end cap. Herein, the first base surface is designed as a surface which results by way of the deepening of the first end cap.

Preferably, the first base ring comprises an end which faces the working recess, wherein a first base diameter which extends perpendicularly to the sliding axis, of the end which faces the working recess, enlarges with an increasing distance to the main movement region. By way of this, one can simplify the pushing of the first sliding ring onto the first base ring. In particular, the end which faces the working recess is designed in a cone-shaped manner.

Preferably, the first sliding sealing section is designed in a flexible manner to the extent that on pressurising the working recess with working fluid via the first venting region, the first sliding sealing section folds away from the first base sealing section, so that the first base venting section and the first sliding venting section are also fluidically connected to one another when the first base sealing section covers the first sliding sealing section along the sliding axis. On account of the folding-away of the first sliding sealing section, the first sliding sealing section then no longer, at least no longer completely bears on the first base venting section when the first sliding sealing section covers the first base sealing section along the sliding axis. By way of this, the working recess can also be pressurised when the first sliding sealing section covers the first base sealing section along the sliding axis. By way of this, a non-return function of the sliding sealing section, with which the pressurising of the working recess is simplified, is rendered possible. In particular, the sliding sealing section folds away in the direction of the first end cap.

Preferably, the first sliding ring is arranged in a first piston deepening of the piston arrangement. By way of this, a position or a position region of the first sliding ring with respect to the piston arrangement can be fixed in a simple manner. In particular, the first piston deepening extends along the movement axis to a greater extent than the first sliding ring. This means that the first piston deepening is longer along the movement axis than the first sliding ring. By way of this, the sliding ring can move relative to the piston arrangement along the movement axis. In this manner, a non-return function can be provided by way of the first sliding ring being arranged with respect to the piston arrangement in a manner such that on pressurising the first pressure chamber the first sliding ring is deflected or displaced relative to the piston arrangement such that working fluid flows past the first sliding ring. Further preferably or alternatively, the first piston deepening is formed in the piston rod.

Preferably, the housing arrangement comprises a first bypass opening which in particular is formed in the first end cap and which independently of a position of the first sliding ring relative to the first base ring fluidically connects the first fluid opening to the working recess. By way of this, in a position in which the first base sealing section covers the first sliding sealing section along the sliding axis, one can prevent the speed of the piston arrangement not being reduced to such an extent that the piston arrangement is not moved further. On account of the first bypass opening, a venting of the working recess is rendered possible independently of the first base ring and the first sliding ring.

Preferably, the first base surface faces inwards and the first sliding surface faces outwards, so that the first base ring at least partly embraces the first sliding ring when the piston arrangement is situated in the first end position, wherein preferably the first base ring is formed as one piece in the first end cap. The first base ring is accordingly designed as an inner contour in the first end cap. On movement of the piston arrangement towards the first end position, the first sliding ring immerses into the first end cap.

According to an alternative embodiment, the first base surface faces inwards and the first sliding surface faces outwards, so that when the piston arrangement is situated in the first end position, the first base ring at least partly embraces the first sliding ring, independently of whether the first base ring is designed as one piece in the first end cap.

Preferably, the cylinder further comprises a second base ring and a second sliding ring wherein the housing arrangement further comprises a second end cap which is fixed to the cylinder housing at the end side in a manner lying opposite the first end cap, wherein the cylinder comprises a second base ring which is fixed to the second end cap, and a second sliding ring which is fixed to the piston arrangement, wherein the housing arrangement comprises a second damping region which is adjacent to the main movement region and a second venting region which is adjacent to the second damping region, wherein the piston arrangement can be moved into a second end position which corresponds to the second venting region, wherein the second sliding ring can be brought onto the second base ring by way of a second sliding movement which runs along the sliding axis and in particular is directed opposite to the first sliding movement, so that a second sliding surface of the second sliding ring which faces the second base ring at least partly covers a second base surface of the second base ring which faces the second sliding ring, along the sliding axis, wherein the second base ring comprises a second base venting section on the second base surface, wherein the second sliding ring comprises a second sliding venting section on the second sliding surface, wherein the second base venting section and/or the second sliding venting section are deepened, wherein the second base venting section is arranged in the second venting region, wherein the second base venting section and the second sliding venting section are fluidically connected to one another when the piston arrangement is situated in the second end position, in order to vent the working recess, wherein the second base ring on the second base surface comprises a second base sealing section which is radially circumferentially closed and is arranged in the second damping region and the second sliding ring on the second sliding surface comprises a radially circumferentially closed second sliding sealing section, wherein the second base venting section and the second sliding venting section are fluidically separated from one another when the second base sealing section covers the second sliding sealing section along the sliding axis and the second sliding ring is situated in the second sliding movement, wherein second end cap comprises a second fluid opening which permits a fluidic connection of the working recess to a fluid device.

All that which has been mentioned above with regard to the first base ring, the first sliding ring, the first damping region, the first venting region, the first end position, the first end cap and the first sliding movement applies in the same manner to the second base ring, the second sliding ring, the second damping region, the second venting region, the second end position, the second end cap and the second sliding movement. Preferably, the first base ring and the second base ring are designed in the same manner. Further preferably, the first sliding ring and the second sliding ring are designed in the same manner.

### BRIEF DESCRIPTION OF THE DRAWINGS

The invention is hereinafter explained in more detail by way of the accompanying drawings and in these are shown:

FIG. 1 a cylinder in a sectioned view,

FIG. 2 a first base ring of the cylinder which is represented in FIG. 1 and a first sliding ring of the cylinder which is represented in FIG. 1., wherein a first base venting section of the first base ring covers a first sliding venting section of the first sliding ring, in a sectioned view,

FIG. 3 the arrangement which is represented in FIG. 2, wherein the first base venting section does not cover the first sliding venting section,

FIG. 4 the arrangement which is represented in FIG. 2 with an alternative first base ring and an alternative first sliding ring,

FIG. 5 the arrangement which is represented in FIG. 3, with the alternative first base ring which is represented in FIG. 4 and the alternative first sliding ring which is represented in FIG. 4,

FIG. 6 the first base ring which is represented in FIG. 4 and 5, in an isometric view,

FIG. 7 the first sliding ring which is represented in FIG. 4 and 5, in an isometric view,

FIG. 8 a further sectioned view of the arrangement which is represented in FIG. 4,

FIG. 9 a further sectioned view of the arrangement which is represented in FIG. 5,

FIG. 10 the arrangement which is represented in FIGS. 2, 4 and 8 with a further alternative first base ring and with a further alternative first sliding ring,

FIG. 11 the arrangement which is represented in FIGS. 3, 5 and 9 with the further alternative first base ring which is represented in FIG. 10 and with the alternative first sliding ring which is represented in FIG. 10,

FIG. 12 the arrangement which is represented in FIGS. 2, 4, 8 and 10 with a further alterative first base ring and a further alternative first sliding ring,

FIG. 13 the arrangement which is represented in FIG. 3, 5, 9 and 11 with the further alternative first base ring which is represented in FIG. 12 and with the further alternative first sliding ring which is represented in FIG. 12,

FIG. 14 the first base ring which is represented in FIG. 12 and 13, in an isometric view,

FIG. 15 the first base ring which is represented in FIG. 10 and 11, in an isometric view,

FIG. 16 a further cylinder in a sectioned view,

FIG. 17 a further first sliding ring in a sectioned view, and

FIG. 18 a further first base ring in a sectioned view.

### DETAILED DESCRIPTION

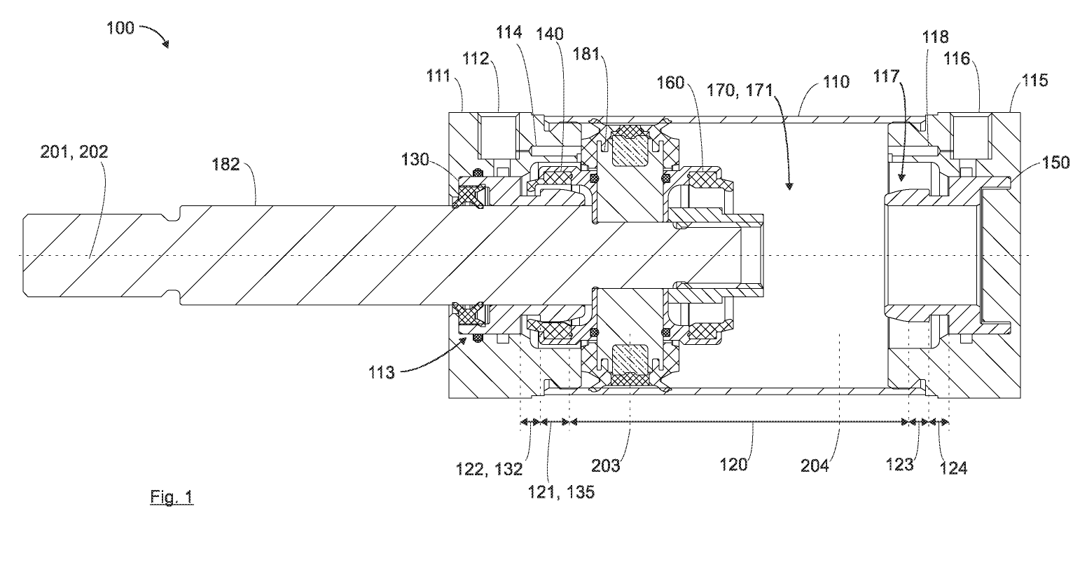

FIG. 1 shows a cylinder 100 in a sectioned view. The cylinder 100 comprises a housing arrangement. The housing arrangement comprises a cylinder housing 110. A working recess 170 is formed in the cylinder housing 110. A piston arrangement is received in the working recess 170. The piston arrangement purely by way of example comprises a working piston 181 and a piston rod 182 which is fixed to the working piston 181. Further by way of example, the working piston 181 divides the working recess 170 into a first pressure chamber 171 and a second pressure chamber which in FIG. 1 is not provided with a reference numeral.

The working piston 181 and hence the piston rod 182 are linearly movable along a movement axis 201 by way of subjecting the working recess 170 to working fluid. The housing arrangement further comprises a first end cap 111 which is fixed to the cylinder housing 110 at the end side to the left and a second end cap 115 which is fixed to the cylinder housing 110 at the end side to the right.

The cylinder 100 comprises a first base ring 130 which is fixed to the first end cap 111 and a first sliding ring 140 which is fixed to the piston arrangement, in particular to the working piston 181. The cylinder 100 further comprises a second base ring 150 which is fixed to the second end cap 115, and a second sliding ring 160 which is fixed to the piston arrangement, in particular to the working piston 181. All that which is stated hereinafter with regard to the first base ring 130 and the first sliding ring 140 applies in the same manner to the second base ring 150 and the second sliding ring 160. Preferably, the first base ring 130 and the second base ring 150 are designed in the same manner. Further preferably, the first sliding ring 140 and the second sliding ring 160 are designed in the same manner.

The housing arrangement comprises a main movement region 120, a first damping region 121 which is adjacent to the main movement region 120 and a first venting region 122 which is adjacent to the first damping region 121. The first damping region 121 in the representation which is shown in FIG. 1 is arranged to the right of the main movement region 120 and the first venting region 122 to the right of the first damping region 121. The housing arrangement further comprises a second damping region 123 which is adjacent to the main movement region 120 and a second venting region 124 which is adjacent to the second damping region 123. The second damping region 123 in the representation which is shown in FIG. 1 is arranged to the left of the main movement region 120 and the second venting region 124 to the left of the second damping region 123.

The piston arrangement, in particular the working piston 181 is movable into a first end position 203 which corresponds to the first venting region 122. Purely by way of example, the piston arrangement, in particular the working piston 181 is movable into a second end position 204 which corresponds to the second venting region 124. The first sliding ring 140 can be brought onto the first base ring 130 by way of a first sliding movement which runs along a sliding axis 202, so that a first sliding surface 141 of the first sliding ring 140 which faces the first base ring 130 at least partly covers a first base surface 131 of the first base ring 130 which faces the first sliding ring 140, along the sliding axis 202. Purely by way of example, the sliding axis 202 and the movement axis 201 run parallel to one another, in particular the sliding axis 202 and the movement axis 201 are congruent.

The first end cap 111 comprises a first fluid opening 112 which permits a fluidic connection of the working recess 170 to a fluid device. Purely by way of example, the second end cap 115 comprises a second fluid opening 116 which likewise permits a fluidic connection of the working recess 170 to a fluid device. In particular, the first fluid opening 112 permits a fluidic connection of the first pressure chamber 171 to the fluid device and the second fluid opening 116 permits a fluidic connection of the second pressure chamber to the fluid device. In the arrangement which is represented in FIG. 1, the piston arrangement, in particular the working piston 181 is positioned in a manner such that the first pressure chamber 171 has a maximal volume and the second pressure chamber has a minimal volume.

Purely by way of example, the first end cap 111 comprises a first receiving deepening 113 in which the first base ring 130 is at least partly received. Further by way of example, the second end cap 115 comprises a second receiving deepening 117 in which the second base ring 150 is at least partly received. On account of the first receiving deepening 113 and/or the second receiving deepening 117, the first base ring 130 and/or the second base ring 150 can be sunk at least partly in the first end cap 111 and in the second end cap 115 respectively. By way of this, the construction space which is required for the cylinder 100 along the movement axis 201 can be reduced.

Purely by way of example, the housing arrangement comprise a first bypass opening 114 which is particular is formed in the first end cap 111 and independently of the position of the first sliding ring 140 relative to the first base ring 130 fluidically connects the first fluid opening 112 to the working recess 170. Further by way of example, the housing arrangement comprises a second bypass opening 118 which in particular is formed in the second end cap 115 and independently of a position of the second sliding ring 160 relative to the second base ring 150 fluidically connects the second fluid opening 116 to the working recess 170.

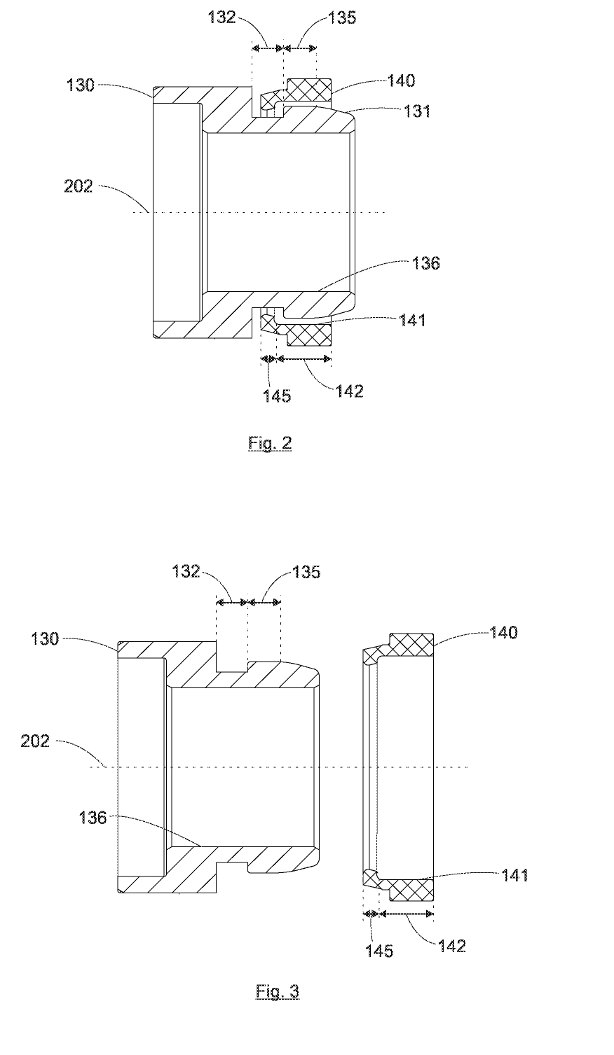

FIG. 2 shows the first base ring 130 of the cylinder 100 which is represented in FIG. 1 and the first sliding ring 140 of the cylinder 100 which is represented in FIG. 1, in a sectioned view. The first base ring 130 comprises a first base venting section 132 on the first base surface 131. The first sliding ring 140 comprises a first sliding venting section 142 on the first sliding surface 141. The first base venting section 132 and the first sliding venting section 142 are deepened. The first base venting section 132 is arranged in the first venting region 122 (cf. FIG. 1). If the piston arrangement, in particular the working piston 181 is situated in the first end position 203 as represented in FIG. 1, then the first base venting section 132 and the first sliding venting section 142 are fluidically connected to one another, in order to vent the working recess 170. For this, the first base venting section 132 covers the first sliding venting section 142 along the sliding axis 202.

The first base ring 130 on the first base surface comprises a first base sealing section 135 which is radially circumferentially closed and is arranged in the first damping region 121. The first sliding ring 140 on the first sliding surface 141 comprises a first sliding sealing section 145 which is radially circumferentially closed.

Purely by way of example, the piston rod 182 passes through the first base ring 130. This means that the first base ring 130 surrounds the piston rod 182 (cf. FIG. 1). Further by way of example, the first base ring 130 comprises a first base sliding surface 136 which is arranged lying opposite the first base surface 131 and on which the piston rod 182 is mounted in a slidingly movable manner (cf. FIG. 1).

FIG. 3 shows the arrangement which is represented in FIG. 2, wherein the first base venting section 132 does not cover the first sliding venting section 142.

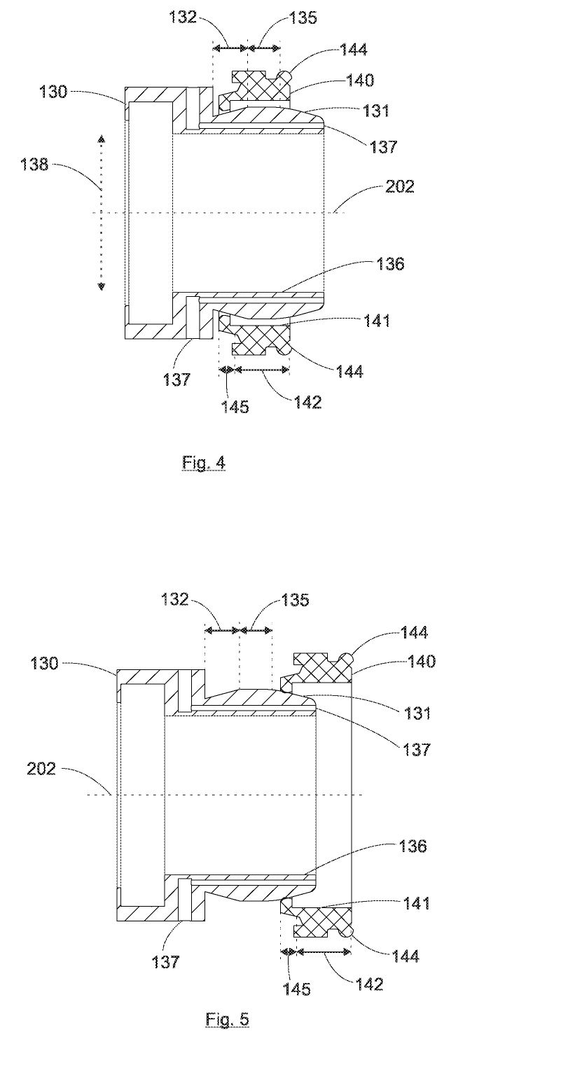

FIG. 4 shows the arrangement which is shown in FIG. 2, with an alternative first base ring 130 and an alternative first sliding ring 140. Regarding the first base ring 130 which is represented in FIG. 4, a first base diameter 138 which extends perpendicularly to the sliding axis 202 reduces in the first base venting section 132 with an increasing distance to the first base sealing section 135. Moreover, the first base ring 130 which is represented in FIG. 4 comprises at least one venting channel 137. Further by way of example, two venting channels 137 are visible in FIG. 4. The venting channel 137 is fluidically connected to the first fluid opening 112. Furthermore, the venting channel 137 is fluidically connected to the working recess 170 independently of the position of the first sliding ring 140.

FIG. 5 shows the arrangement which is represented in FIG. 3, with the alternative first base ring 130 which is represented in FIG. 4 and with the alternative first sliding ring 140 which is represented in FIG. 4. It can be recognised in FIG. 5 that the first base venting section 132 and the first sliding venting section 142 are fluidically separated when the first base sealing section 135 covers the first sliding sealing section 45 along the sliding axis 202 and the first sliding ring 140 is situated in the first sliding movement.

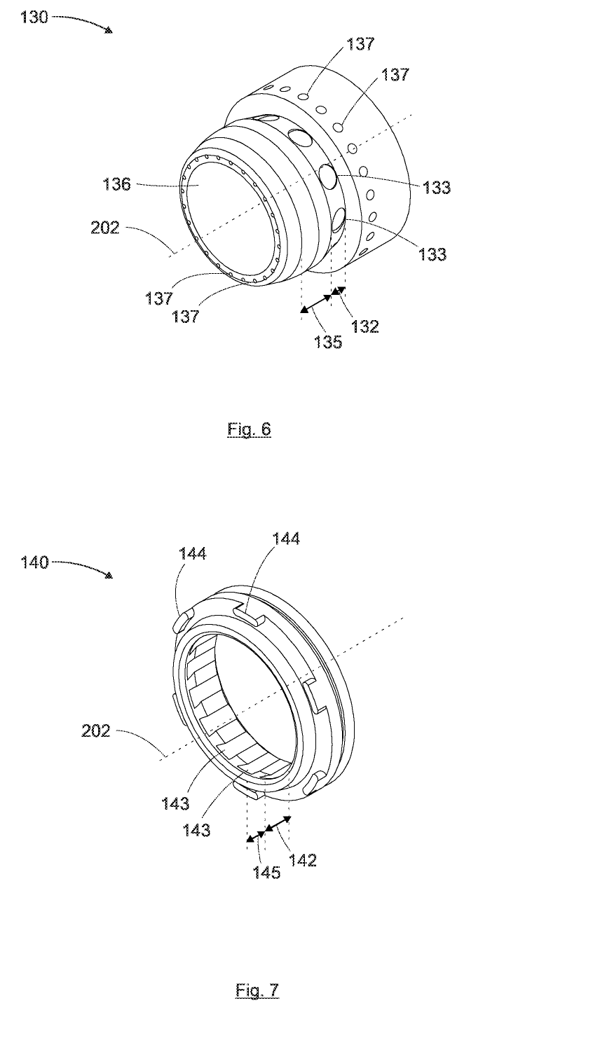

FIG. 6 shows the first base ring 130 which is represented in FIG. 4 and 5, in an isometric view. The first base ring 130 comprises at least one venting pocket 133 in the first base venting section 132. Purely by way of example, the first base ring 130 comprises a plurality of venting pockets 133, wherein only two venting pockets 133 have been provided with a reference numeral in FIG. 6 for reasons of a better overview.

FIG. 7 shows the first sliding ring 140 which is represented in FIG. 4 and 5, in a isometric view. The first sliding ring 140 comprises at least one sliding stop 144 (cf. also FIG. 4 and 5). Purely by way of example, the first sliding ring 140 comprises a multitude of sliding stops 144, wherein only two sliding stops 144 are provided with a reference numeral in FIG. 7 for reasons of a better overview. By way of the sliding stops 144, one can prevent the first sliding ring 140 from being moved too far away from the first base ring 130 which is to say from being moved in its receiver too far away from the first base ring 130, given the pressuring of the first pressure chamber 171. On the one hand, a corresponding movement of the first sliding ring 140 is limited by the sliding stops 144 and on the other hand working fluid can flow along in the intermediate spaces which are formed between the sliding stops 144, which is to say flow through between the sliding stops 144.

Moreover, the first sliding ring 140 which is represented in FIG. 7 comprises at least one venting deepening 143 with which an additional volume for the passage of working fluid is created in the deepened first sliding venting section 142. Purely by way of example, the first sliding ring 140 comprises a multitude of venting deepenings 143, wherein only two venting deepenings 143 are provided with reference numerals in FIG. 7 for reasons of a better overview.

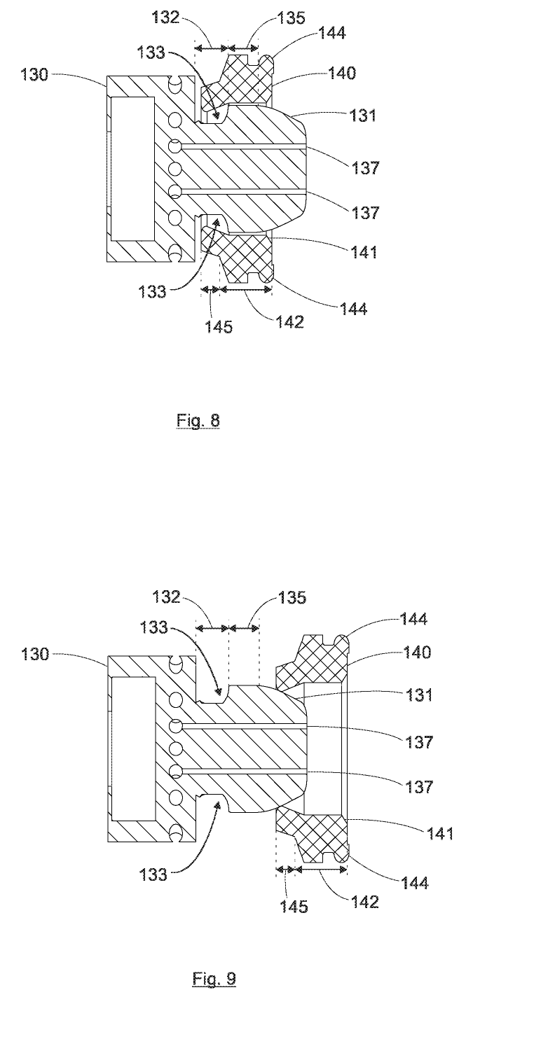

FIG. 8 shows a further sectioned view of the arrangement which is represented in FIG. 4 and Fig, 9 shows a further sectioned view of the arrangement which is represented in FIG. 5. With regard to the sectioned views which are represented in FIG. 8 and 9, the section runs so far on the far side of the sliding axis 202 that the first base sliding surface 136 is no longer visible. With regard to the sectioned view which is represented in FIG. 8, a venting pocket 133 is visible each at the top and bottom. With regard to the position of the first sliding ring 140 with respect to the first base ring 130 and represented in FIG. 8, it can be recognised that in the first base venting section 132 a venting take space via the cone-shaped tapering of the first base surface 131 which from coming the first base sealing section 135 increasingly tapers in the direction of the first base venting section 132, as well as additionally via the venting pockets 133.

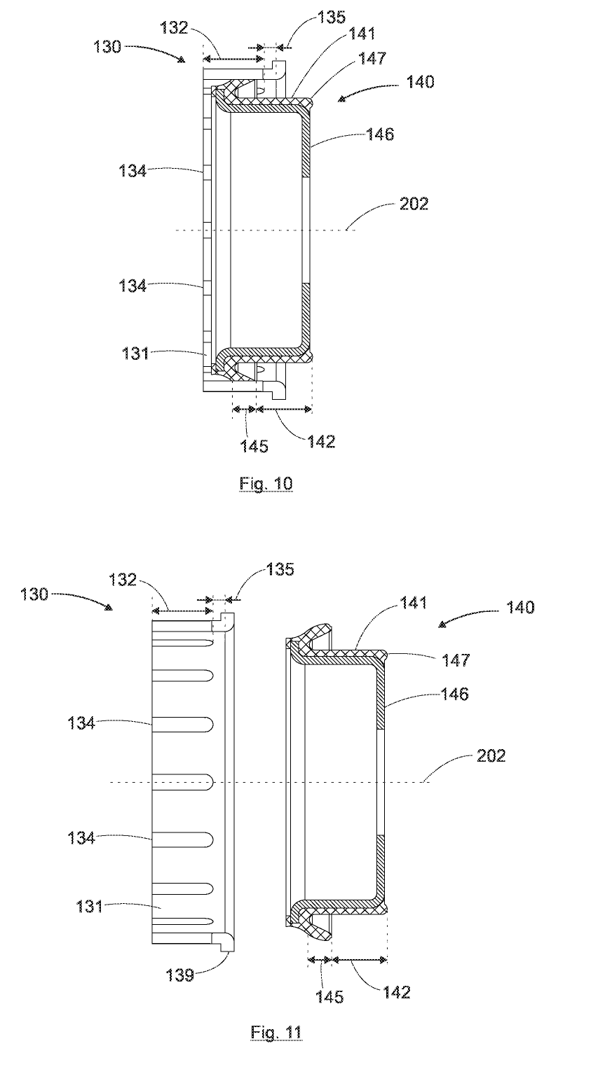

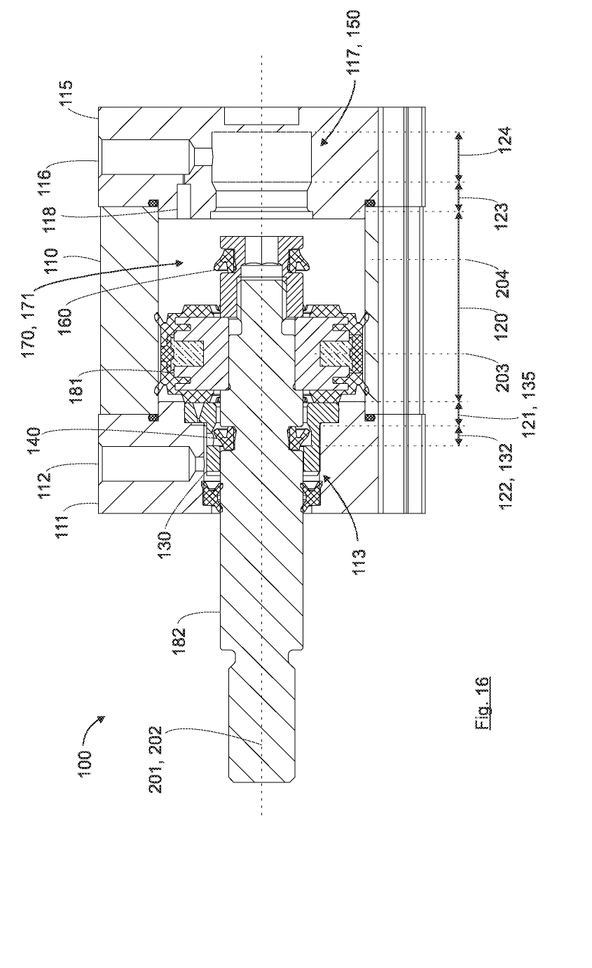

FIG. 10 and 11 each in a sectioned view show a further alternative first base ring 130 and a further alternative first sliding ring 140. FIG. 15 shows the first base ring which is represented in FIG. 10 and 11, in an isometric view. With regard to the first base rings 130 and first sliding rings 140 which are shown in FIG. 1 to 9, the first sliding ring 140 surrounds which is to say encloses the first base ring 120 in each case. With regard to the first base ring 130 and the first sliding ring 140 which are shown in FIGS. 10 and 11, this is precisely the other way around, which is to say the first base ring 130 surrounds which is to say encloses or embraces the first sliding ring 140.

The first base ring which is shown in FIG. 10, 11and15 comprises at least one venting slot 134 in the first base venting section 132. A venting slot 134 is a deepening which locally passes through the first base ring 130 in a complete manner. With regard to the first base ring 130 which is shown in FIG. 10 and 11, the venting slot 134 passes through the first base ring 130 perpendicularly to the sliding axis 202. In particular, the first base ring 130 comprises a multitude of venting slots 134, wherein only two venting slots 134 are provided with a reference numeral for reasons of a better overview.

The first sliding ring 140 which is shown in FIGS. 10 and 11 is designed of two elements and comprises a support structure 146 and a sealing structure 147. The support structure 146 is enclosed by the sealing structure 147. Basically, the first sliding ring 140 is preferably designed of a rubber-elastic material, so that it is possible for the first sliding sealing section 145 to nestle on the first base sealing section 135 in a sealing manner. The aforementioned sealing nestling function is assumed by the sealing structure 147 with regard to the first sliding ring 140 which is represented in FIG. 10 and 11. The sealing structure 147 is designed with little material, by which means the stability of the first sliding ring 140 is basically compromised. In order to ensure the stability of the first sliding ring 140 even given a sealing structure 147 which is designed with little material, in particular one envisages the support structure 146 being formed from a stiff material, for example of a metal such as a steel.

The first base ring 130 which is shown in FIG. 10 and 11, purely by way of example is designed in a sleeve-like manner. Further by way of example, the first base ring 130 comprises a base collar 139 which is designed for example as a bent-up region to the first base ring 130 which otherwise runs parallel to the sliding axis 202. Preferably, the base collar 139 extends perpendicularly to the sliding axis 202. Further preferably, a run-in aid for the first sliding ring 140 is provided by way of the base collar 139, with which run-in aid it is possible for the first sliding ring 140 to reliably slide into the first base ring 130. Moreover, the base collar 139 can serve as a stop on manufacture of the cylinder 100, so that an exact pressing of the first base ring 130 into the first end cap 111 is simplified.

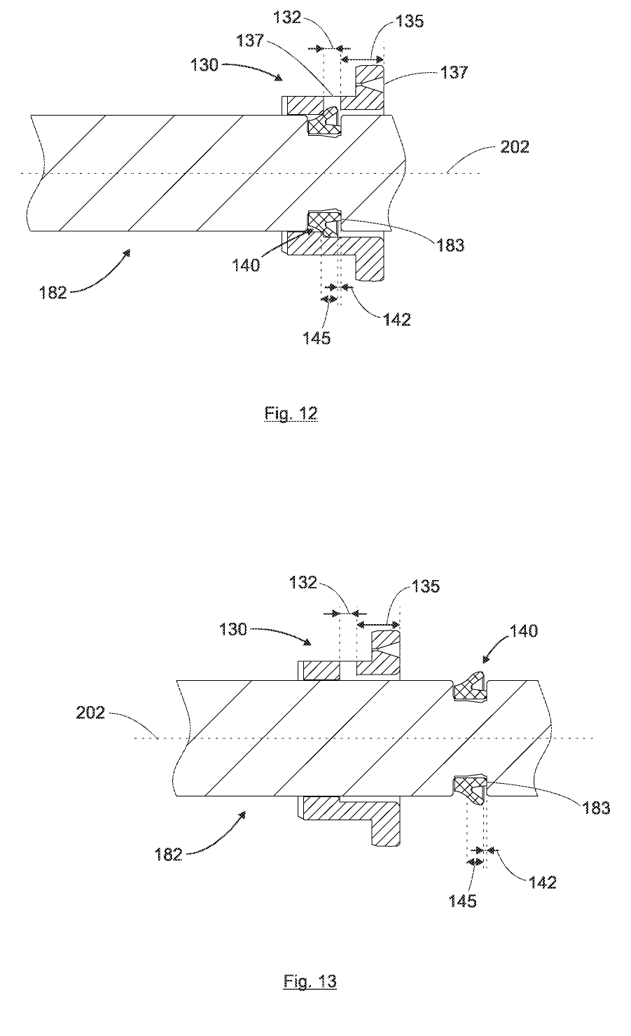

FIG. 12 and 13 show a further alternative first base ring 130 and a further alternative first sliding ring 140. Moreover, a detail of the piston rod 182 is shown in FIG. 12 and 13. Purely by way of example, the piston rod comprises a first piston deepening 183 in which the first sliding ring 140 is received. By way of this, in comparison to an alternative attachment of the first sliding ring 140 to the piston arrangement, for example to the working piston 181 as is shown in FIG. 1, a construction space which is necessary for the first sliding ring 140 can be reduced in a plane which extends perpendicularly to the sliding axis 202, by which means the cylinder 100 as a whole can be designed smaller.

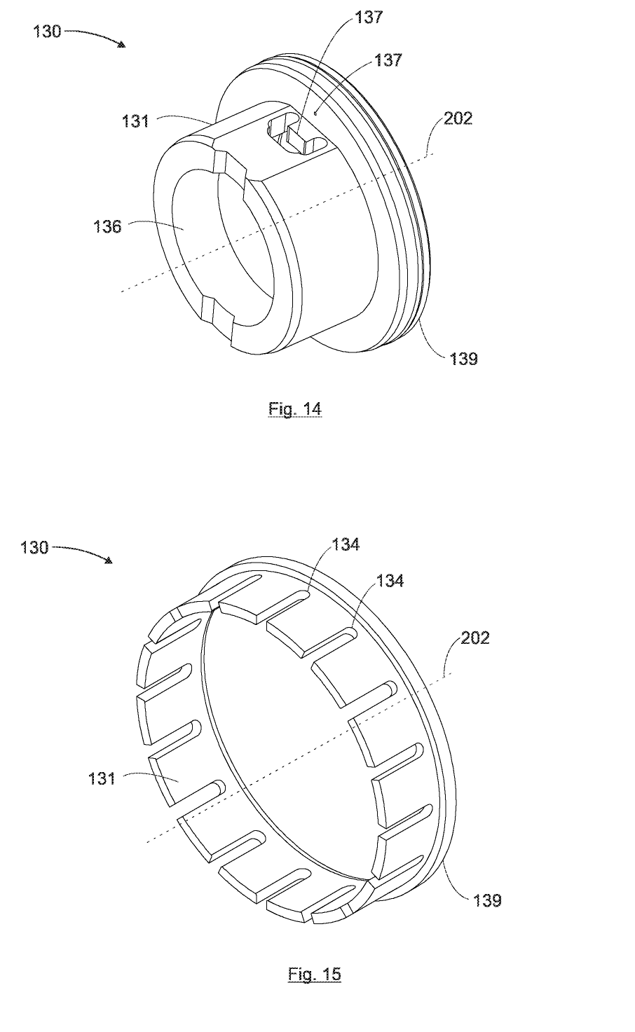

FIG. 14 shows the first base ring 130 which is represented in the FIG. 12 and 13, in an isometric view. The first base ring 130 comprises a flattened outer contour, wherein a venting channel 137 is arranged in the flattened region of the outer contour. In particular, the flattening is designed in a plane manner. The venting channel 137 which is arranged in this region runs out in this flattened region of the first base ring 130. The flattened region of the first base ring 137 herewith serves as a channel for the pressuring and venting of the working recess 170. Preferably, the venting channel 137 which is provided in the flattened region of the outer contour is designed in a fork-like manner towards the base collar 139. Accordingly, this venting channel 137 branches in the direction of the base collar 139.

The first base ring 130 furthermore comprises a further venting channel 137 which passes through the base collar 139 and in particular is aligned parallel to the sliding axis 202. This further venting channel 137, as the first bypass opening 114 and second bypass opening 118 which are provided with regard to the cylinder 100 which is represented in FIG. 1, serves as a bypass, which is to say as a permanent fluidic connection between the working recess 170 and the first fluid opening 112 and second fluid opening 116 respectively.

Preferably, apart from the outer contour of the first base ring 130, an outer contour of the first receiving deepening 113 which faces this flattening is likewise flattened in the region of the venting channel 137and is designed in the same manner as the outer contour of the first base ring 130. In such a manner, one can prevent the first base ring 130 being rotated in the first receiving deepening 113, in particular about the sliding axis 202 or about a rotation axis which is arranged parallel to the sliding axis. By way of this, one can ensure in a simple manner that the venting channel 137 is aligned with the first fluid opening 112 given an assembly of the first base ring 130 in the first end cap 111.

FIG. 16 shows a further cylinder 100 in a sectioned view. The cylinder 100 which is represented in FIG. 16 comprises a further first base ring 130. With regard to the first base ring 130 which is represented in FIG. 16, a first base diameter which extends perpendicularly to the sliding axis 202 increases in the first base venting section 132 with an increasing distance to the first basis sealing section 135. Herein, the first base diameter is an inner diameter of the first base ring 130. On account of the aforementioned increasing enlargement of the first base diameter, the further the first sliding venting section is moved in the direction of the first end position which is not provided with a reference numeral in FIG. 16 for reasons of a better overview, the more does the volume which is spanned between the first base surface and the first sliding surface in the region in which the first sliding venting section 132 and the first sliding venting section overlap along the sliding axis 202 enlarge. This is also the case for the first base ring 130 which is represented in FIG. 4 to 6, 8 and 9. However, the first base ring 130 which is represented in FIG. 16, in contrast to the first base ring 130 which is represented in FIG. 4 to 6, 8 and 9 is designed in a manner such that this embraces the first sliding ring 140, whereas with regard to the first base ring 130 which is represented in FIG. 4 to 6, 8 and 9, the first sliding ring 140 embraces the first base ring 130.

The second base ring 150 is an integral constituent of the second end cap 115. In particular, the second base ring 150 and the second end cap 115 are designed as one piece. This can be achieved by way of the second base ring 150 being designed as a respective deepening of the second end cap 115. The design of the second base ring 150 which has been explained above can be conferred upon the first base ring 130 and the first end cap 111.

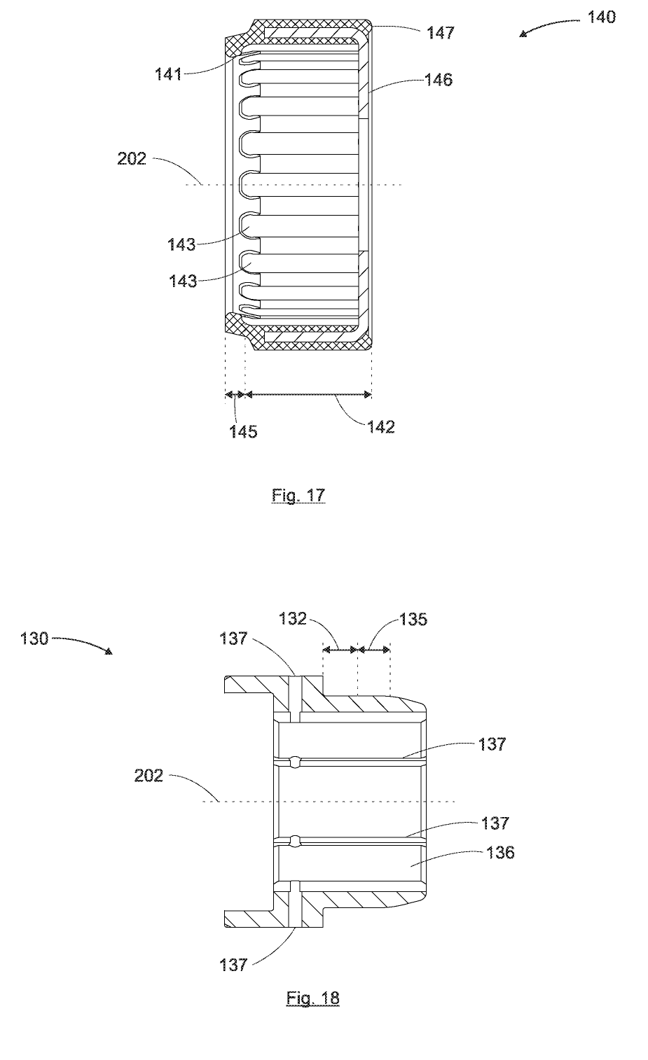

FIG. 17 shows a further first sliding ring 140 in a sectioned view which is designed of two elements as with the first sliding ring 140 which is shown in FIG. 10 and 11 and hence comprises the support structure 146 and the sealing structure 147. Furthermore, the first sliding ring 140 which is shown in FIG. 17 comprises a multitude of venting deepenings 143 as with the first sliding ring 140 which is represented in FIG. 7.

FIG. 18 shows a further first base ring 130 in a sectioned view, said first base ring comprising a multitude of venting channels 137 which are each designed as an open deepening of the first base sliding surface 136. The venting channels 137 run parallel to the sliding axis 202 in the region of the first base sliding surface 136. Coming from the first base sealing section 135 towards the first base venting section 132, after the first base venting section 132 the venting channels 137 run away from the first base sliding surface 136 perpendicularly to the sliding axis 202 and run out in an outer circumferential surface of the first base ring 130.

1. A cylinder with a housing arrangement which comprises:
a cylinder housing in which a working recess is formed, in which working recess a piston arrangement is received, said piston arrangement being linearly movable along a movement axis by way of subjecting the working recess to working fluid,
wherein the housing arrangement further comprises a first end cap which is fixed to the cylinder housing at the end side, wherein the cylinder comprises a first base ring which is fixed to the first end cap and a first sliding ring which is fixed to the piston arrangement, wherein the housing arrangement comprises a main movement region, a first damping region which is adjacent to the main movement region and a first venting region which is adjacent to the first damping region, wherein the piston arrangement is movable into a first end position which corresponds to the first venting region, wherein the first sliding ring can be brought onto the first base ring by way of a first sliding moment which runs along a sliding axis, so that along the sliding axis a first sliding surface of the first sliding ring which faces the first base ring at least partly covers a first base surface of the first base ring which faces the first sliding ring, wherein the first base ring comprises a first base venting section on the first base surface, wherein the first sliding ring comprises a first sliding venting section on the first sliding surface, wherein the first base venting section and/or the first sliding venting section are deepened, wherein the first base venting section is arranged in the first venting region, wherein the first base venting section and the first sliding venting section are fluidically connected to one another when the piston arrangement is situated in the first end position, in order to vent the working recess, wherein the first base ring on the first base surface comprises a first base sealing section which is radially circumferentially closed and is arranged in the first damping region and the first sliding ring on the first sliding surface comprises a radially circumferentially closed first sliding sealing section, wherein the first base venting section and the first sliding venting section are fluidically separated from one another when the first base sealing section covers the first sliding sealing section along the sliding axis and the first sliding ring is situated in the first sliding movement, wherein the first end cap comprises a first fluid opening which permits a fluidic connection of the working recess to a fluid device.

2. The cylinder according to claim 1, wherein the first base ring comprises at least one venting channel which is fluidically connected to the first fluid opening, wherein the venting channel is fluidically connected to the working recess independently of the position of the first sliding ring.

3. The cylinder according to claim 1, wherein the piston arrangement comprises a working piston and a piston rod which is fixed to the working piston, wherein the piston rod passes through the first end cap.

4. The cylinder according to claim 3, wherein the piston rod passes through the first base ring.

5. The cylinder according to claim 4, wherein the first base ring comprises a first base sliding surface which is arranged lying opposite to the first base surface and on which the piston rod is mounted in a slidingly movable manner.

6. The cylinder according to claim 2, wherein the venting channel is designed as an open deepening of the first base sliding surface.

7. The cylinder according to claim 1, wherein in the first base venting section, a first base diameter which extends perpendicularly to the sliding axis reduces with an increasing distance to the first base sealing section.

8. The cylinder according to claim 1, wherein in the first base venting section, a first base diameter which extends perpendicularly to the sliding axis enlarges with an increasing distance to the first base sealing section.

9. The cylinder according to claim 7, wherein the first base ring comprises at least one venting pocket in the first base venting section.

10. The cylinder according to claim 1, wherein the first base ring comprises at least one venting slot in the first base venting section.

11. The cylinder according to claim 1, wherein the first base surface faces outwards and the first sliding surface faces inwards, so that the first sliding ring at least partly embraces the first base ring when the piston arrangement is situated in the first end position, wherein preferably the first base ring is designed in a sleeve-like manner.

12. The cylinder according to claim 1, wherein the first end cap comprises a first receiving deepening in which the first base ring is at least partly received.

13. The cylinder according to claim 1, wherein the first base ring is an integral constituent of the first end cap, wherein preferably the first base ring and the first end cap are designed as one piece.

14. The cylinder according to claim 1, wherein the first base ring comprises an end which faces the working recess, wherein a first base diameter which extends perpendicularly to the sliding axis, of the end which faces the working recess, enlarges with an increasing distance to the main movement region.

15. The cylinder according to claim 1, wherein the first sliding sealing section is designed in a flexible manner to the extent that on pressurising the working recess with working fluid via the first venting region, the first sliding sealing section folds away from the first base sealing section, so that the first base venting section and the first sliding venting section are also fluidically connected to one another when the first base sealing section covers the first sliding sealing section along the sliding axis.

16. The cylinder according to claim 1, wherein the first sliding ring is arranged in a first piston deepening of the piston arrangement, wherein the piston deepening is formed in the piston rod.

17. The cylinder according to claim 1, wherein the housing arrangement comprises a first bypass opening which is formed in the first end cap and which independently of a position of the first sliding ring relative to the first base ring fluidically connects the first fluid opening to the working recess.

18. The cylinder according to claim 1, wherein the first base surface faces inwards and the first sliding surface faces outwards, so that the first base ring at least partly embraces the first sliding ring when the piston arrangement is situated in the first end position, wherein the first base ring is formed as one piece in the first end cap.

19. The cylinder according to claim 1, further comprising a second base ring and a second sliding ring, wherein the housing arrangement further comprises a second end cap which is fixed to the cylinder housing at the end side in a manner lying opposite the first end cap, wherein the cylinder comprises a second base ring which is fixed to the second end cap and a second sliding ring which is fixed to the piston arrangement, wherein the housing arrangement comprises a second damping region which is adjacent to the main movement region and a second venting region which is adjacent to the second damping region, wherein the piston arrangement can be moved into a second end position which corresponds to the second venting region, wherein the second sliding ring can be brought onto the second base ring by way of a second sliding movement which runs along the sliding axis and in particular is directed opposite to the first sliding movement, so that a second sliding surface of the second sliding ring which faces the second base ring at least partly covers a second base surface of the second base ring which faces the second sliding ring, along the sliding axis, wherein the second base ring comprises a second base venting section on the second base surface, wherein the second sliding ring comprises a second sliding venting section on the second sliding surface, wherein the second base venting section and/or the second sliding venting section are deepened, wherein the second base venting section is arranged in the second venting region, wherein the second base venting section and the second sliding venting section are fluidically connected to one another when the piston arrangement is situated in the second end position, in order to vent the working recess, wherein the second base ring on the second base surface comprises a second base sealing section which is radially circumferentially closed and is arranged in the second damping region and the second sliding ring on the second sliding surface comprises a radially circumferentially closed second sliding sealing section, wherein the second base venting section and the second sliding venting section are fluidically separated from one another when the second base sealing section covers the second sliding sealing section along the sliding axis and the second sliding ring is situated in the second sliding movement, wherein second end cap comprises a second fluid opening which permits a fluidic connection of the working recess to a fluid device.
Fehler! Textmarke nicht definiert.
